(19) United States
(12) Patent Application Publication
(10) Pub. No.: US 2002/0169663 A1
(43) Pub. Date: Nov. 14, 2002

(54) Method of advertising and promoting a book in a visual media, and an advertising product for advertising a book and the like in a visual media

(76) Inventors: Julia Zborovsky-Fenster, New York, NY (US); Ilya Zborovsky, Dix Hills, NY (US)

Correspondence Address: Ilya Zborovsky, 6 Schoolhouse Way, Dix Hills, NY, 11746, US

(21) Appl. No.: 09/854,118

(22) Filed: May 14, 2001

(51) Int. Cl. G06F 17/60

(52) U.S. Cl. 705/14; 707/104.1

(57) ABSTRACT

A book and the like in a visual media such as in movies, theaters, television, Internet, Intranet and other proprietary networks, broadband delivery system, and the like is advertised by analyzing a content of a book; selecting at least one portion of the book, and staging a scene which represents content of the selected portion of the book.

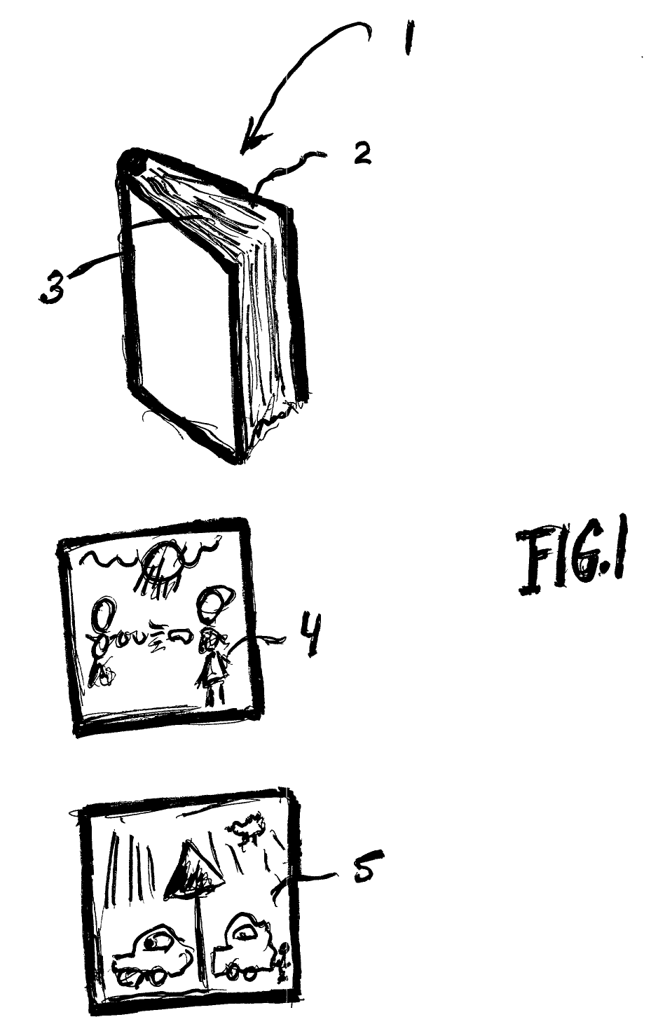

### BACKGROUND OF THE INVENTION

The present invention relates a method of advertising and promoting a book in a visual media such as in movies, theaters, television, Internet, Intranet and other proprietary networks, broadband delivery system and the like, and an advertising product for advertising a book and the like in a visual media.

It is known that books are advertised in visual media such as for example television, Internet, etc. by showing a portion of a text of the book, or reading a portion of the book. However, no additional visual information is provided which would be attractive to potential users of a book and the like.

### SUMMARY OF THE INVENTION

Accordingly, it is an object of present invention to provide a method of advertising and promoting a book and the like in a visual media such as in movies, theaters, on television, on Internet, Intranet and other proprietary networks, broadband delivery system and the like, and an advertising product for advertising a book and the like in a visual media, which is a further improvement of the inventive methods and products.

In keeping with these objects and with others which will become apparent hereinafter, one feature of present invention resides in a method of advertising a book and the like in a visual media such as on television and the like, which has the steps of analyzing a content of a book; selecting at least one portion of the book and staging a scene which represents the selected portion of the book.

In accordance with another feature of present invention, an advertising product is proposed which has at least one stage scene which corresponds to a portion of the book and is stageable in a visual media, such as in movies, theaters, on television, on Internet, Intranet and other proprietary networks, broadband delivery system or the like.

When the method is performed and an advertising product is designed in accordance with the present invention, it provides a very efficient familiarization of potential readers of a book with its content in a visual form, and increases efficiency of advertising and promoting.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawing is a view schematically illustrating a new method of advertising and promoting a book in a visual media such as on television, on Internet and the like, and an advertising product for advertising a book and the like in a visual media.

### DESCRIPTION OF PREFERRED EMBODIMENTS

In accordance with the present invention a book which is identified as a whole with reference numeral 1 is to be advertised and promoted in mass media, in particular in a visual media such an in movies, theaters, on television, computer media such as Internet, Intranet and other proprietary networks, broadband delivery systems, etc.

The book as always has a plurality of portions or at least pages. Two of the pages are identified with reference numerals 2 and 3.

In order to advertise the book 1, in accordance with the present invention at least one scene 4 is staged which corresponds to a portion of the book for example to a content of page 2 of the book. The scene can be staged with actors, can be made as a cartoon scene, as a combination of both, etc.

In accordance with another feature of present invention, another portion of another page 3 of the book can be also made in a scene 5 which is staged with actors, as a carton, as a combination of both, etc.

Any number of the portions of pages of the book can be staged. The staged product or products is shown in a visual mass media, for example in movies, theaters, on television, on the Internet, Intranet and other proprietary networks, broadband delivery systems, etc. As a result, potential readers can familiarize themselves not only with fragments of the text which can be shown in the visual medium or read in an audio medium, but also can see staged actions corresponding to content of respective portions of the book.

This substantially increase the visualization of the book by users and efficiency of advertising and promoting.

It is to be understood that the book is given here only as an example, since any printed matter can be advertised the same inventive way.

It will be understood that each of the elements described above, or two or more together, may also find a useful application in other types of constructions differing from the types described above.

While the invention has been illustrated and described as embodied in a method of advertising a book in a visual media such as television and the like, and an advertising product for advertising a book and the like in a visual media, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of advertising and promoting a book and the like in a visual media such as television and the like, comprising the steps of analyzing a content of a book; selecting at least one portion of the book; and staging a scene which represents a content of the selected portion of the book.

2. A method as defined in claim 1, wherein said staging a scene includes using actors for the staging of the scene.

3. A method as defined in claim 1, wherein said staging a scene includes using animation.

4. A method as defined in claim 1; and further comprising the step of selecting another portion; and staging another scene representing a content of the other portion of the book.

5. An advertising and promotion product for advertising and promoting a book in a visual media, comprising at least one staged scene which corresponds to a content of portion of the book and is stageable in the video media, such as a television or the like.

6. An advertising product as defined in claim 5, wherein said staged scene is scene with participation of actors.

7. An advertising product as defined in claim 5, wherein said staged scene is an animated scene.

8. An advertising product as defined in claim 4; and further comprising at least another staged scene which represents content of another portion of the book and is stageable in a visual media, such as television and the like.
